(19) United States
(12) Patent Application Publication
(10) Pub. No.: US 2011/0195382 A1
(43) Pub. Date: Aug. 11, 2011

(54) TRANSFERABLE SPIN ART TOY

(76) Inventors: Elliot Rudell, Torrance, CA (US); George T. Foster, Placerville, CA (US); Joseph Cernansky, Redondo Beach, CA (US)

(21) Appl. No.: 13/019,201

(22) Filed: Feb. 1, 2011

Related U.S. Application Data
(60) Provisional application No. 61/303,259, filed on Feb. 10, 2010.

(51) Int. Cl. G09B 11/10

(52) U.S. Cl. 434/84

(57) ABSTRACT

An activity assembly that is used to transfer an artistic design onto an object. The assembly includes at least one template that can be loaded into a housing. A colorant can be dispensed into the housing. The housing rotates the template and causes the colorant to move about the template to form a design. The template can then be removed from the housing and pressed onto an object such as a shirt. The template transfers the colorant onto the object, so that an artistic design is formed onto the object.

### CROSS-REFERENCE TO RELATED APPLICATIONS

This application claims priority to Application No. 61/303,259 filed on'Feb. 10, 2010.

### BACKGROUND OF THE INVENTION

1. Field of the Invention

The present invention relates to an art activity toy that can be used to transfer a design onto an item such as clothing.

2. Prior Art

Art and activity toys are a popular and financially lucrative segment of the toy business. There have been marketed toys that engage children in the creative process of creating artwork, decorating and building collectible elements, etc. Plastic model kits provide for the customizable assembly of toy cars, vehicles and other objects.

One very popular classic creative activity is called “spin art” which typically involves a large spinning platform onto which a recipient element, such as a piece of paper, is placed. As the platform spins, the user applies preferably colored inks, dyes or paints onto the paper. The centrifugal force of the spinning platform displaces the ink so that a random design is left on the paper. Using different colors one atop the other, the results can be striking. At carnivals and state fairs, large commercial-quality platforms can be set up to allow users to securely mount and then spin shirts and sweatshirts, as it is very desirable to create spin art on wearable items. Inks, dyes and paints are then applied to the spinning apparel. The end result is a beautiful, one-of-a-kind creation that can be worn by the end user. There are many problems associated with prior art spin-art systems. First, the platform and the spinning mechanism are costly because these components must be large enough and powerful enough to hold and spin a complete shirt or sweatshirt. Second, sometimes the end result of the spinning-application of paints is not as pretty as the user might want—but once the colors are applied to the fabric, the user does not have the ability to change or erase the spun design.

### BRIEF SUMMARY OF THE INVENTION

An activity assembly that is used to transfer an artistic design onto an object. The assembly includes at least one template that can be loaded into a housing. A colorant can be dispensed into the housing. The housing rotates the template and causes the colorant to move about the template to form a design. The template can then be removed from the housing and pressed onto an object such as a shirt. The template transfers the colorant onto the object, so that an artistic design is formed onto the object.

### BRIEF DESCRIPTION OF THE DRAWINGS

FIG. 1 is an illustration of an embodiment of an activity assembly;

FIG. 2 is an illustration of an alternate embodiment of the activity assembly;

FIG. 3 is an illustration of an activity assembly with a plurality of different templates;

FIG. 4 is an illustration of an alternate embodiment of an activity assembly with a template that can be attached to a rotating platform;

FIG. 5 is an illustration showing a ring that is used to capture a portion of a piece of clothing;

FIG. 6 is an illustration showing a colorant being poured into a cavity of a housing;

FIG. 7 is an illustration showing a template being pressed onto a piece of clothing; and,

FIG. 8 is an illustration showing an artistic design that is transferred onto the piece of clothing by the template.

### DETAILED DESCRIPTION

Disclosed is an activity assembly that is used to transfer an artistic design onto an object. The assembly includes at least one template that can be loaded into a housing. A colorant can be dispensed into the housing.

The housing rotates the template and causes the colorant to move about the template to form a design. The template can then be removed from the housing and pressed onto an object such as a shirt. The template transfers the colorant onto the object, so that an artistic design is formed onto the object.

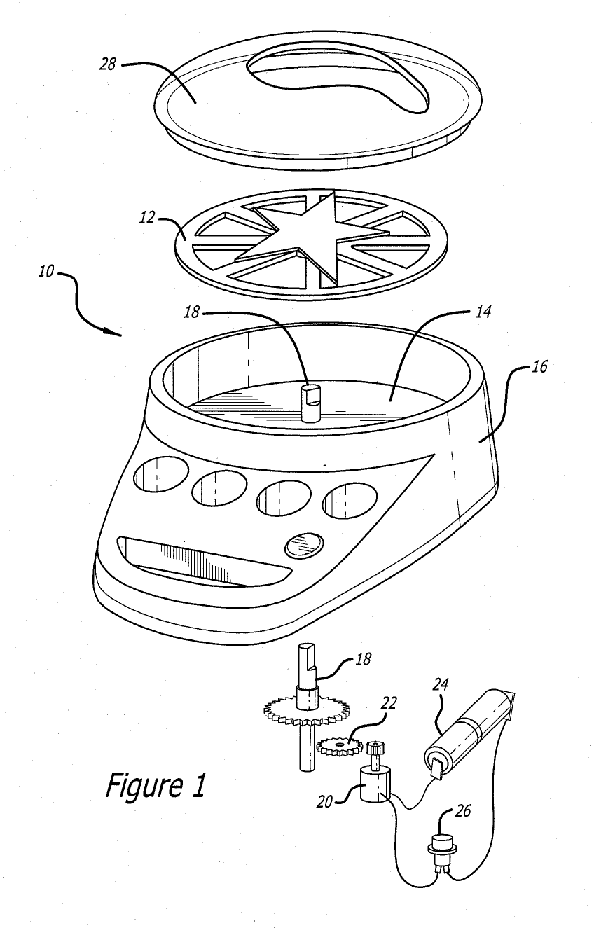

Referring to the drawings by reference numbers, FIG. 1 shows an embodiment of an activity assembly 10. The assembly 10 includes a template 12 that can be placed into a cavity 14 of a housing 16. The template 12 can be coupled to a post 18. The post 18 may be coupled to an electric motor 20 by a gear assembly 22. The electric motor 20 may be powered by a battery 24 and connected to an ON/OFF switch 26. The cavity 14 can be enclosed by a cover 28. Pressing the switch 26 into an ON position activates the motor 20 and causes the template 12 to spin.

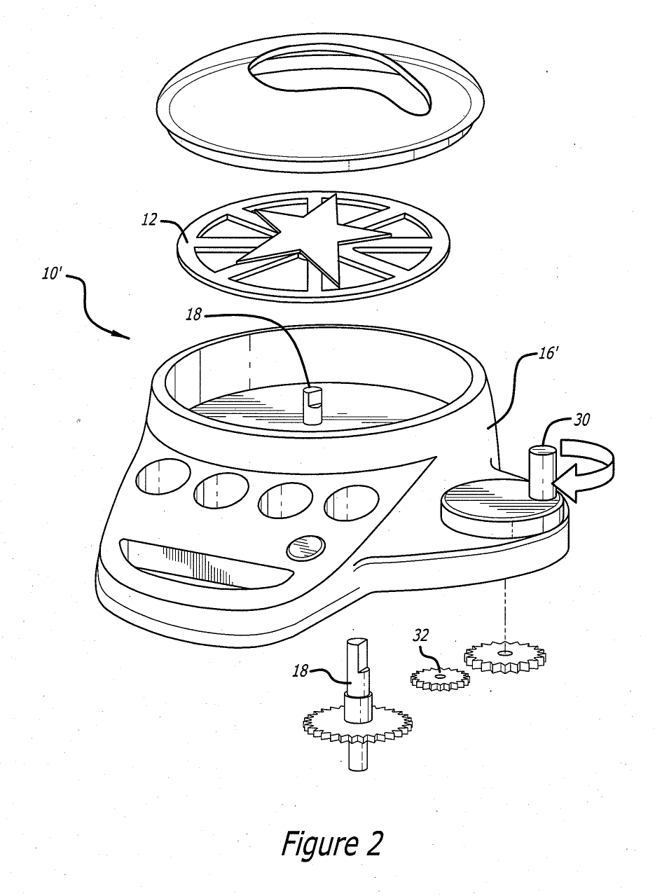

FIG. 2 shows an alternate embodiment of an activity assembly 10′. In this embodiment the housing 16′ includes a handle 30 that is coupled to the post 18 by a gear assembly 32. Rotating the handle 30 causes the template 12 to spin.

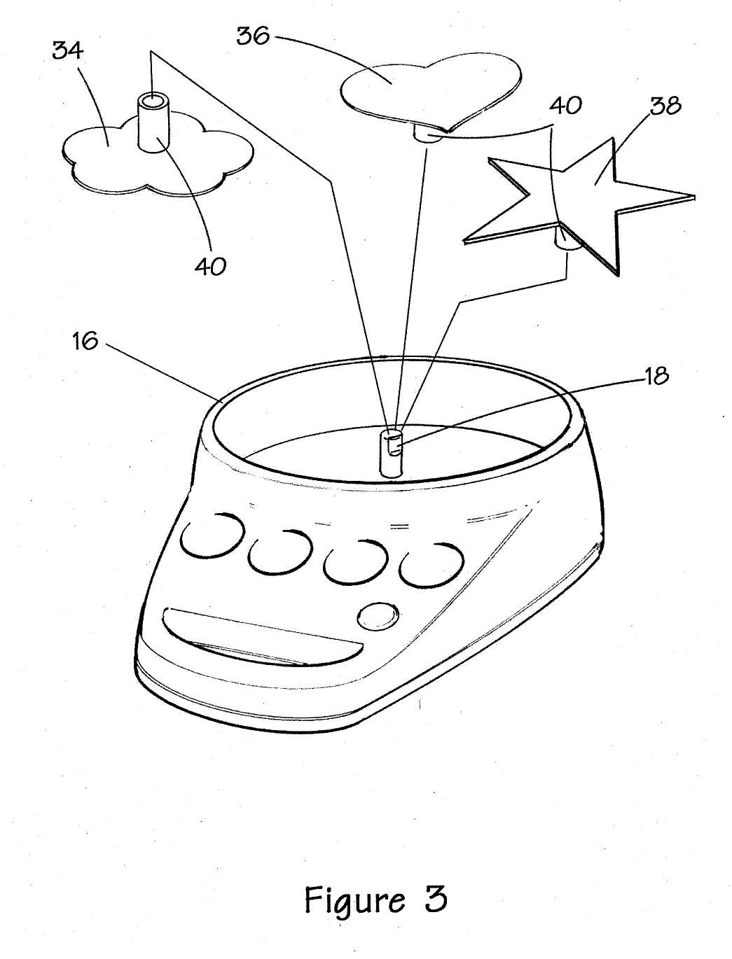

As shown in FIG. 3 the assembly may include a plurality of different templates 34, 36 and 38. Each template 34, 36 and 38 may be have a different shape. By way of example, FIG. 3 shows templates 34, 36 and 38 with cloud, heart and star shapes, respectively. One of the templates can be loaded into the housing at a time. Each template 34, 36 and 38 may have a sleeve 40 that can be inserted onto the post 18.

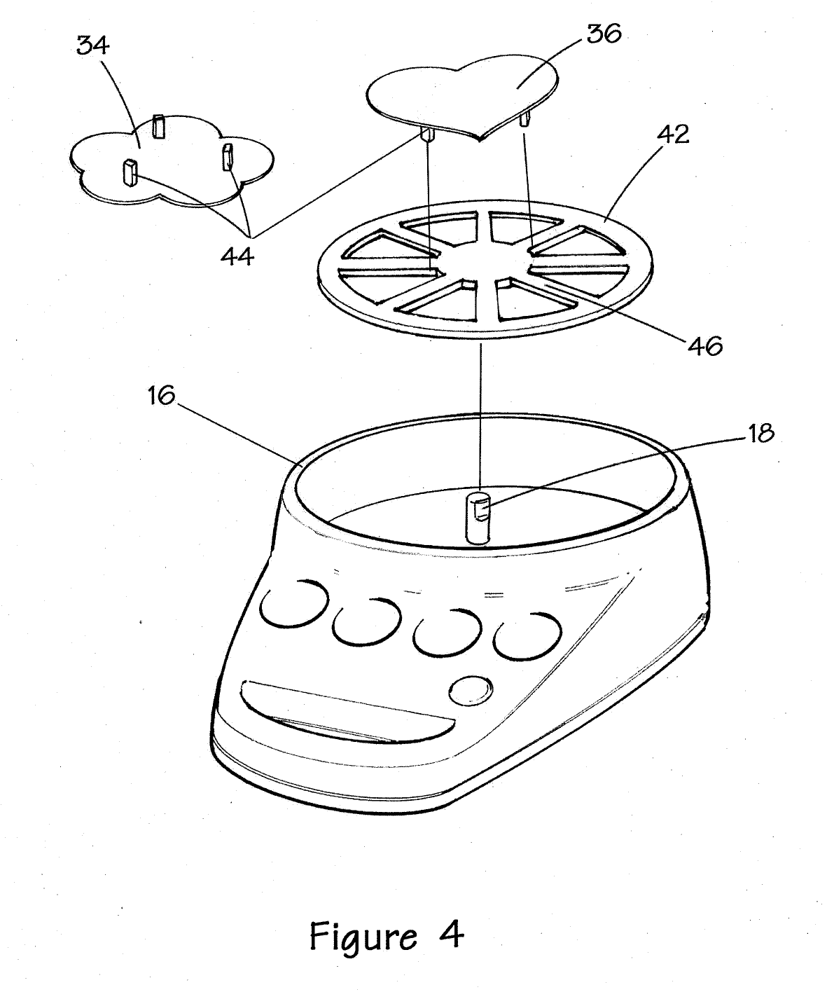

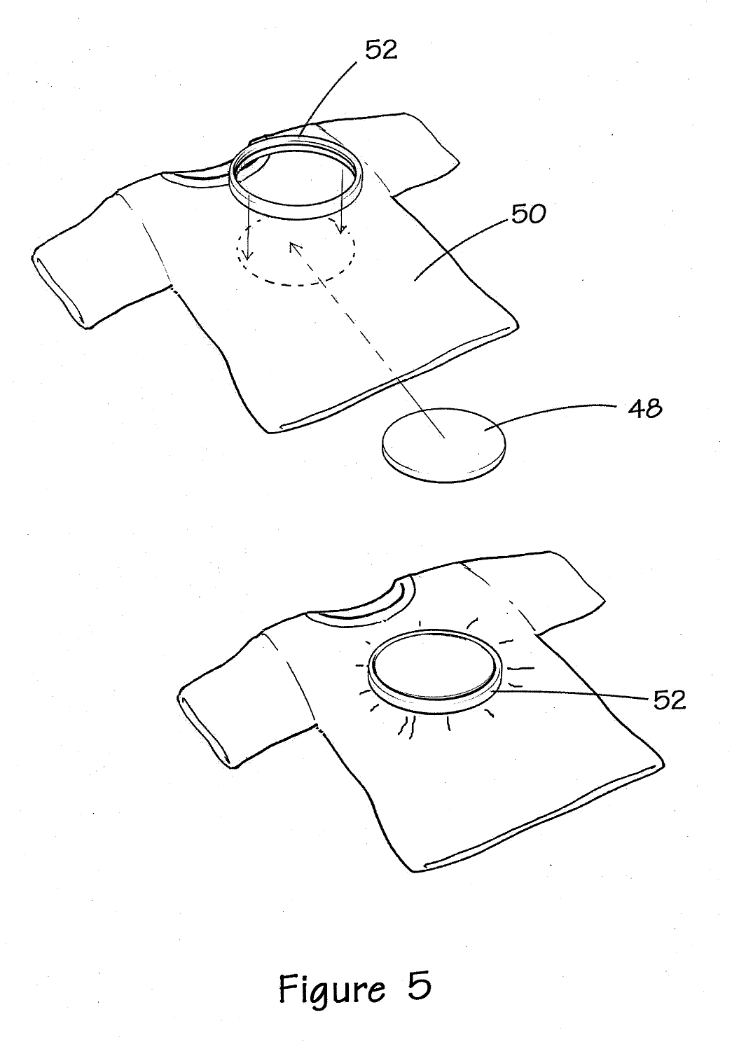

As shown in FIG. 4, each template 34 or 36 can be coupled to a platform 42 that is attached to the post 18 of a housing. The platform 42 can be adapted to couple more than one template 34 and 36 to the housing. The templates 34 and 36 may include tabs 44 that press onto corresponding spokes 46 of the platform 42. The activity assembly can be used to transfer an artistic design onto an object such as a piece of clothing. FIG. 5 shows a disk 48 that can be placed under a shirt 50. A ring 52 can be pressed onto the shirt 50 such that the ring 52 and disk 48 capture a portion of the shirt 50 to hold that portion flat and taut.

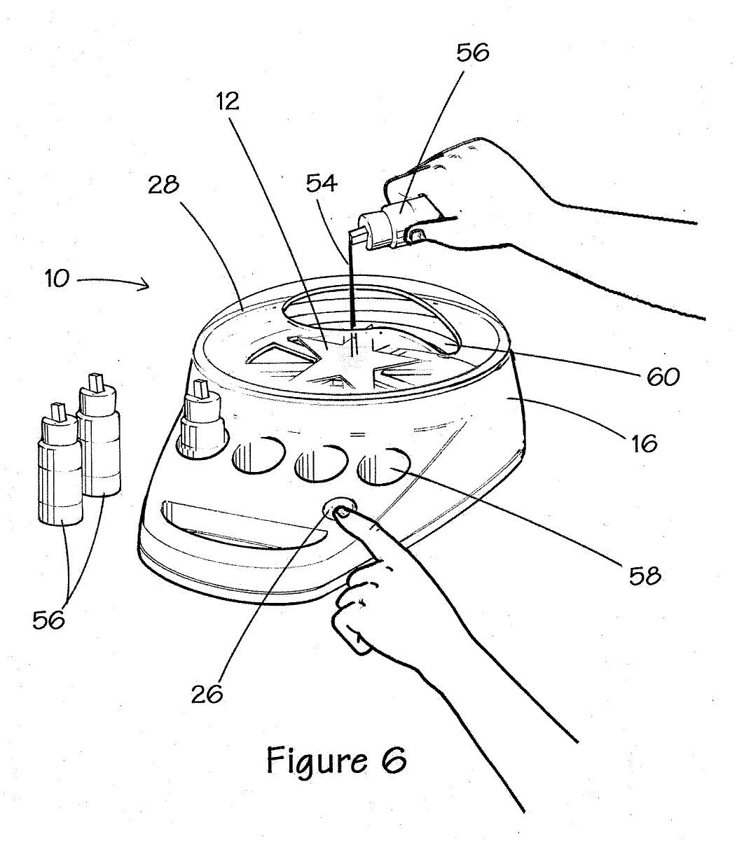

As shown in FIG. 6, the assembly includes a colorant 54 that can be dispensed into the cavity 14 of the housing 16. The colorant 54 may be dispensed from a dispenser 56. Each assembly may include a plurality of dispensers 56 that each include a colorant of a different color. The dispensers 56 may be stored in corresponding pockets 58 of the housing 16. The housing cover 28 may include an opening 60 that allows the colorant to be dispensed while the cover 28 is in place. The colorant 54 may be paint, ink or any other material that can form an artistic design and be transferred onto a template to an object.

After a colorant 54 is dispensed into the housing cavity 14 the switch 26 is pushed to the ON position. The motor is activated and the template is spun. The spinning motion causes the colorant to move about the template. Additional colorants can be added and spun about the template. The colorants can also be added while the template is spinning. The timing of adding the colorants and spinning the template can be varied to create different artistic designs.

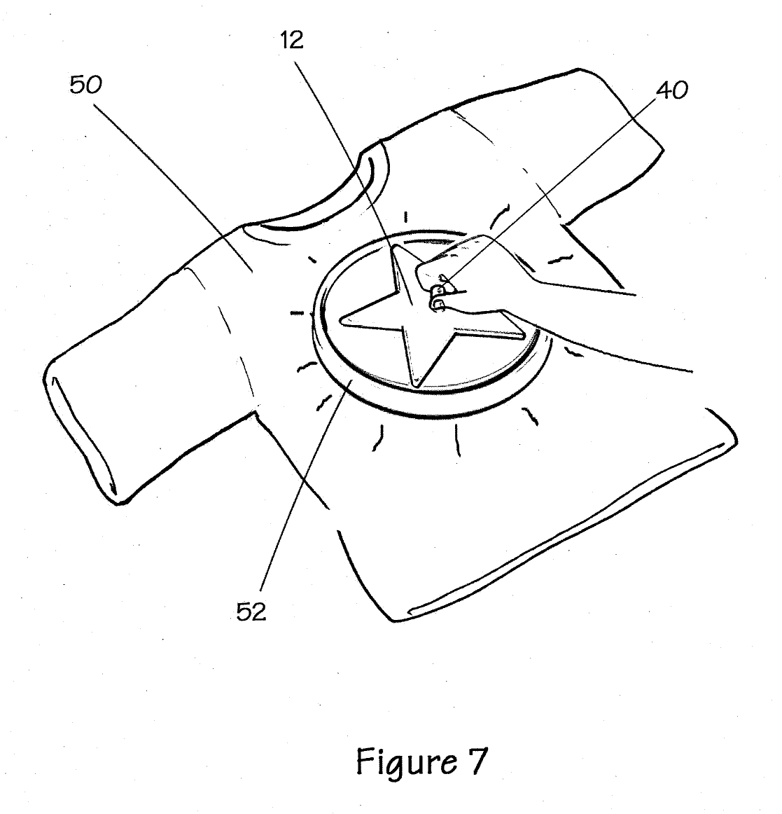

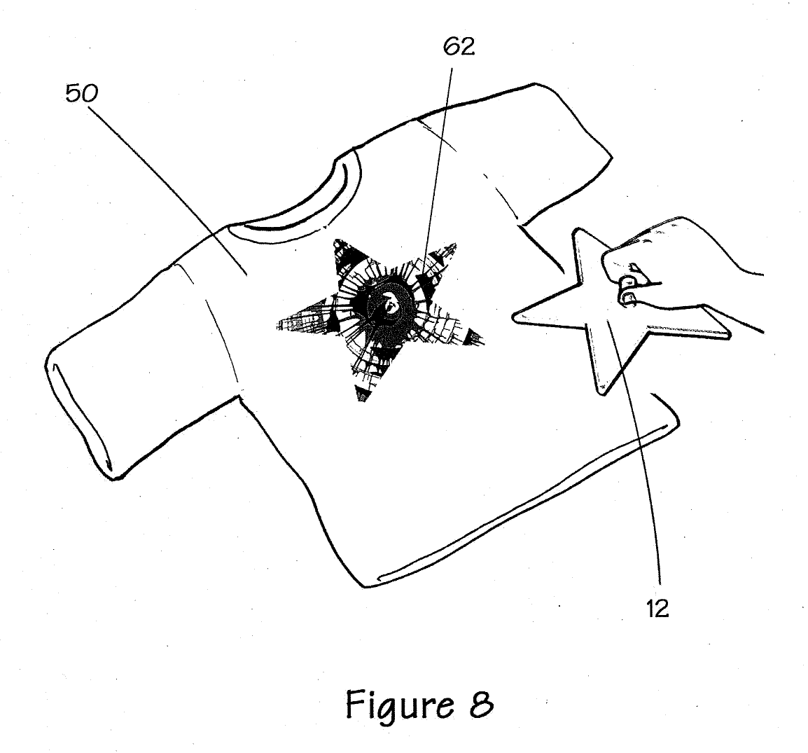

After the design is formed, the template 12 is removed from the housing and pressed onto the shirt 50 as shown in FIG. 7. The template sleeve 40 can function as a handle for the user to hold the template 12. The ring 52 and underlying disk (not shown) stretch the shirt so that the template 12 is pressed onto a flat surface. Pressing the template 12 causes the wet colorant 54 to be transferred onto the shirt 50. The template 12 is removed and an artistic design 62 is formed onto the shirt 50 as shown in FIG. 8. The templates are preferably constructed from a material such as plastic or plastic laminated cardboard, so that any residual colorant can be wiped away. This allows the template to be readily reused for another design. Having the design formed in the housing allows the user to remove an undesirable design before application to an object. This allows the user to create different artistic designs before choosing a design to transfer onto the object.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, although transfer of an artistic design onto a shirt is shown and described, it is to be understood that the design could be transferred onto any object such as a lunchbox, a hat, or a wall.

What is claimed is:

1. A spin art activity assembly, comprising:
at least one template;
a colorant that can be dispensed onto said template; and,
a housing that spins said template to move said colorant about said template.

2. The activity assembly of claim 1, wherein said housing includes an electric motor that spins said template.

3. The activity assembly set of claim 1, wherein said housing includes a handle that can be rotated to spin said template.

4. The activity set of claim 1, wherein said housing includes a cover that encloses a cavity of said housing that contains said template.

5. The activity assembly of claim 4, further comprising a container that holds said colorant and said container can be manipulated to dispense said colorant into said cavity.

6. The activity assembly of claim 1, wherein said colorant is paint.

7. The activity assembly of claim 1, further comprising a ring that can capture a portion of a piece of clothing and said template can be manipulated to transfer said colorant onto the piece of clothing.

8. A method for transferring colorant onto an object, comprising:
loading a template into a housing;
dispensing colorant into the housing;
spinning the template to move the colorant about said template;
removing the template from the housing; and, pressing the template onto an object to transfer the colorant onto the object.

9. The method of claim 8, wherein the template is rotated by a motor.

10. The method of claim 8, wherein the template is rotated by moving a handle of the housing.

11. The method of claim 8, further comprising placing a cover onto the housing before spinning the template.

12. The method of claim 8, further comprising manipulating a ring to capture a portion of a piece of clothing and pressing the template onto the captured piece of clothing.
